(19) United States
(12) Patent Application Publication
(10) Pub. No.: US 2012/0216691 A1
(43) Pub. Date: Aug. 30, 2012

(54) BLADE FOR SILK-SCREEN PRINTING ON A PRINT SUPPORT

(75) Inventors: Gianfranco Pasqualin, Spresiano (IT); Andrea Baccini, Mignagola Di Carbonera (IT); Giorgio Cellere, Torri Di Quartesolo (vi) (IT); Luigi De Santi, Spresiano (IT); Marco Galiazzo, Padova (pd) (IT); Tommaso Vercesi, Treviso (IT)

(73) Assignee: Applied Materials, Inc., Santa Clara, CA (US)

(21) Appl. No.: 13/394,135

(22) PCT Filed: Sep. 2, 2009
(86) PCT No.: PCT/EP10/62847

§ 371 Date: May 16, 2012

(30) Foreign Application Priority Data
Sep. 3, 2009 (IT) UD2009A000155

(51) Int. Cl. B05C 17/08

(52) U.S. Cl. 101/126

(57) ABSTRACT

An apparatus for screen printing a surface of a substrate includes a screen printing net, a print extremity element, and a supporting structure supporting the print extremity element. The supporting structure includes a slider coupled to the print extremity element and adapted to guide the movement of the print extremity element in a first direction, a support frame having a housing that is associated with a portion of the slider so as to allow movement of the slider relative to the support frame, and an actuation member coupled to the slider. The print extremity element urges a print material through the screen printing net onto the surface of the substrate. The actuation member positions the print extremity element relative to the screen printing net in the first direction, and includes magnets disposed within the housing of the support frame, and an electric coil disposed proximate to the magnets.

### CROSS-REFERENCE TO RELATED APPLICATIONS

This application claims benefit of International Patent Application Ser. No. PCT/EP2010/062847 filed Sep. 2, 2010, which claims the benefit of Italian Patent Application Serial Number UD2009A000155, filed Sep. 3, 2009, which is herein incorporated by reference.

### FIELD OF THE INVENTION

The present invention concerns a blade for the silk-screen printing of one or more print tracks on a substrate, for example for the silk-screen printing of conductive tracks on plate elements for electronics, or similar elements, such as a wafer, a substrate or thin sheet, comprising silicon in order to make photovoltaic cells. However, it cannot be excluded that another specific substrate, or print support, may be provided, typical of other fields in which a printing operation is provided.

### BACKGROUND OF THE INVENTION

It is known that a technique to make conductive tracks on silicon-based wafers, in particular but not only for photovoltaic cells, is silk-screen printing, using suitable print materials, such as for example conductive pastes or inks, and a suitable silk-screen net, on whose surface an emulsion is disposed, appropriately incised according to the desired development of the tracks to be made.

Silk-screen printing provides to use one or more blades by means of which the print material is deposited on the silk-screen net.

The print material is drawn by the blade on the net thanks to a movement of linear translation obtained by means of a motor that moves the blade along a horizontal plane parallel to the plane on which the net lies, usually identified as plane XY.

Furthermore, the blade is normally also mobile orthogonally to the lying plane of the net, in a direction usually identified as direction Z, generally vertical, for a movement towards/away from the net.

The orthogonal movement in direction Z is obtainable by means of a synchronous linear motor of the brushless type, having excitation with permanent magnets, such as the one described for example in the European patent application EP-A-1.320.180 or EP-A-1.320.181.

In particular, the known linear motor comprises an armature, slider or mobile cursor, equipped with a plurality of compartments inside which respective electric coils are stably housed, and a fixed bar on which a plurality of permanent magnets are mounted, disposed during use facing the electric coils. The mobile armature of the motor is made of aluminum or alloys thereof, or of ceramic material, and is also suitable to house a ferromagnetic bar that cooperates with the coils so as to close the magnetic circuit.

The functioning principle of linear motors of this type exploits the repulsive force that is created by sequentially inverting the direction of circulation of the electric current circulating in an electric coil every time the electric coil moves from a position facing a magnet with a certain polarity, for example positive, to a position facing a magnet with a negative polarity.

However, state-of-the-art linear motors as above have switching disturbances and consequent control problems when the coils pass from a position facing a magnet with a positive pole to a position facing a magnet with a negative pole, or vice versa.

Consequently, these control difficulties often do not allow to guarantee those characteristics of resolution, accuracy, pressure control and printing conditions that are simultaneously required in carrying out silk-screen printing, especially in the field of silk-screen printing of silicon wafers for photovoltaic cells.

The European patent application EP-A-0.768.141 discloses a punching machine with a three axis movement which is used to prepare the substrates destined for making multi-layer electric circuits.

The known punching machine is used to make micro-holes that are then filled, in a subsequent operation, to make desired electric connections.

The silk-screen printing operation in question has completely different problems from the punching machine described in the above patent application. In particular, silk-screen printing needs precision positioning and progressive movement toward/away from the net and control of the operating pressure on the net and reliability, which are not required in the punching operation, in which, for example, the working pressure is necessarily the pressure sufficient to make the micro-holes and does not need to be modulated on each occasion and continuously.

Purpose of the present invention is to achieve a blade for silk-screen printing that allows a regulation and fine control of the operativeness of the blade, in particular of its position with respect to the net and the pressure or force that is exerted by the blade on the net and the printing conditions, preventing the above disadvantages due to switching.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a blade according to the present invention is used for the silk-screen printing of one or more print tracks on substrates by means of a print material able to be deposited through a net below.

The blade according to the invention comprises a print extremity to print the print material and a supporting structure able to support the print extremity.

The supporting structure comprises a fixed support frame and a slider mobile with respect to the support frame, which positions the print extremity at least with respect to the net below.

The blade also comprises actuation means able to determine the movement of the slider with respect to the support frame.

According to one feature of the present invention, the actuation means comprise a linear actuator of the voice coil type.

The use of a linear actuator of the voice coil type is advantageous in that it allows a simpler, more precise and reliable control of the movement, which is particularly useful in the application to silk-screen printing as here.

The present invention therefore allows a regulation and fine control of the operativeness of the blade, in particular the pressure or force that is exerted by the blade on the net and of the printing conditions, preventing the disturbances due to switching that are typical of the state of the art.

According to one form of embodiment, the invention uses a voice coil actuator to control the movement of the printing head and the relative print net in the direction or axis Z, conventionally identified as the axis orthogonal, generally vertical, to a plane, identified as XY, parallel to the plane on which the net lies, generally horizontal in a printing head.

According to one form of embodiment, the voice coil linear actuator comprises a plurality of permanent magnets able to generate a desired constant magnetic field, and a single electric coil able to be fed by electric current that interacts with said magnetic field in order to generate a magnetic force that allows the reciprocal movement of the slider and the support frame.

According to one embodiment of the present invention, a system controller is provided to regulate the intensity of electric current circulating in the electric coil, according to the desired position that the print extremity is to assume and/or the desired pressure or force with which said print extremity has to act on the net.

According to one form of embodiment, the system controller comprises memorization means in which an electronic map is memorized of determinate values of intensity of the electric current circulating in the electric coil at least according to the possible reciprocal positions of the magnets and coils and hence between the support frame and the slider.

The use of an electronic map of the position of the electric coil with respect to the magnets is advantageous since it allows to obtain precision positioning and the progressive movement toward/away from the net, and control of the pressure operating on the net.

In particular, in this way it is possible to define a plurality of print modes for the printing operation, each with a desired printing position and pressure/force.

For example, when the electric coil is in a position distant from the magnets, it is possible to compensate the greater force of attraction required by increasing the intensity of current circulating in the electric coil. Or, for a given position, it is possible to selectively apply a desired printing pressure, or a desired printing pressure profile or development in the course of the printing operation.

According to a variant, the magnets are attached to said support frame and the electric coil is attached to the slider. Consequently, in this case the magnetic field acting on the electric coil draws the slider into movement.

One particularity of the invention is that, when no power is applied, and hence with no current circulating in the electric coil, the blade descends downward due to gravity and the voice coil motor works by holding it in the raised position. This has the advantage that the weight of the blade is used to determine the pressure in a desired way on the net.

In an alternative embodiment, the magnets are attached to the slider and the electric coil is attached to the support frame.

According to a variant embodiment, the blade comprises a rocker arm connection plate that supports the print extremity.

The rocker arm plate is attached to a lower connection end of the slider by means of a pivoting element able to allow a desired oscillation of the print extremity around a pivoting axis.

According to said variant embodiment, the blade also comprises micrometric regulation means, associated with the frame, to regulate the oscillation of the print extremity.

The micrometric regulation means, according to a variant, comprise linear actuation means able to be activated to act on peripheral ends of the rocker arm plate in order to selectively regulate the amplitude of the oscillation and the angular play of the print extremity around the pivoting axis.

Another feature of the present invention concerns a printing head for the silk-screen printing of one or more print tracks on substrates comprising a blade according to the present invention as described above.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic isometric view of a processing system in which the present invention is used;

FIG. 2 is a schematic plan view of the system depicted in FIG. 1;

FIG. 3 is a perspective view of a blade according to the present invention;

FIG. 4 is a front view of the blade in FIG. 3;

FIG. 5 is a perspective view of part of the blade in FIG. 3;

FIG. 6 is a lateral view of the blade in FIG. 3;

FIG. 7 is a lateral section of the blade in FIG. 3.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION OF A PREFERENTIAL FORM OF EMBODIMENT

With reference to the attached drawings, a blade 10 according to the present invention is used for the silk-screen printing in a suitable printing head of a print material, in this case paste for silk-screen printing, for example but not only, conductive paste, on a silk-screen net, in order to reproduce desired tracks, for example conductive, on substrates, in this case plate elements for electronics or suchlike, located below the net, for example silicon-based wafers to make photovoltaic cells.

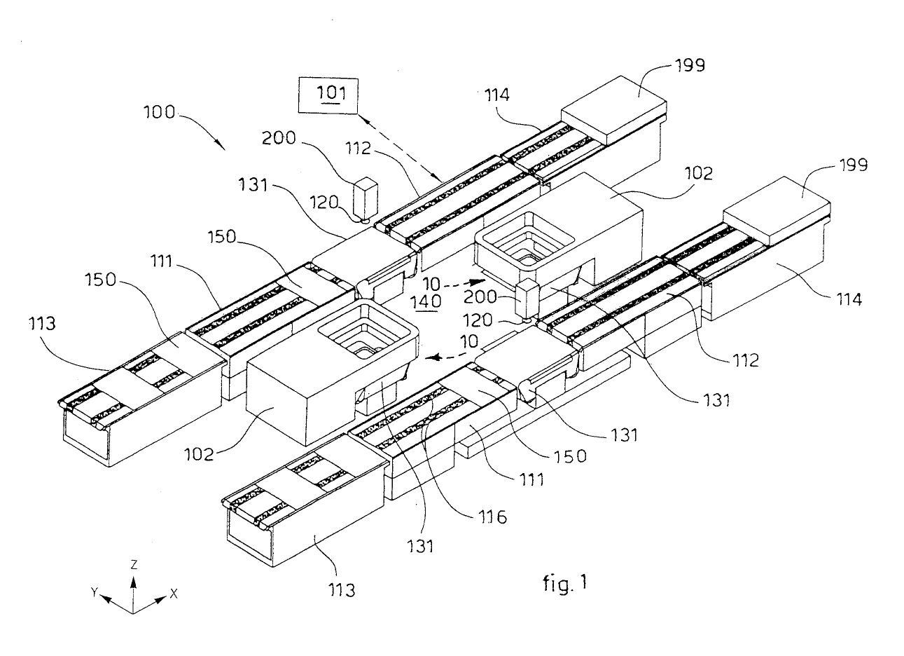

FIG. 1 is a schematic isometric view of a substrate screen printing processing system, or system 100, having screen printing components, which are configured to screen print a patterned layer of material on a substrate 150. In particular the system 100 provides printing heads 102 each having a blade 10 according to the present invention. In one embodiment, the system 100 generally includes two incoming conveyors 111, an actuator assembly 140, a plurality of processing nests 131, a plurality of processing heads 102, two outgoing conveyors 112, and a system controller 101.

The incoming conveyors 111 are configured in a parallel processing configuration so that each can receive unprocessed substrates 150 from an input device, such as an input conveyor 113, and transfer each unprocessed substrate 150 to a processing nest 131 coupled to the actuator assembly 140. Additionally, the outgoing conveyors 112 are configured in parallel so that each can receive a processed substrate 150 from a processing nest 131 and transfer each processed substrate 150 to a substrate removal device, such as an exit conveyor 114.

In one embodiment, each exit conveyor 114 is adapted to transport processed substrates 150 through an oven 199 to cure material deposited on the substrate 150 via the processing heads 102.

In one embodiment, substrates 150 are microcrystalline silicon substrates used for processing solar cells thereon. In another embodiment, substrates 150 are green tape ceramic substrates or the like.

The system 100 may comprise other substrate processing modules requiring precise movement and positioning of the substrates for processing.

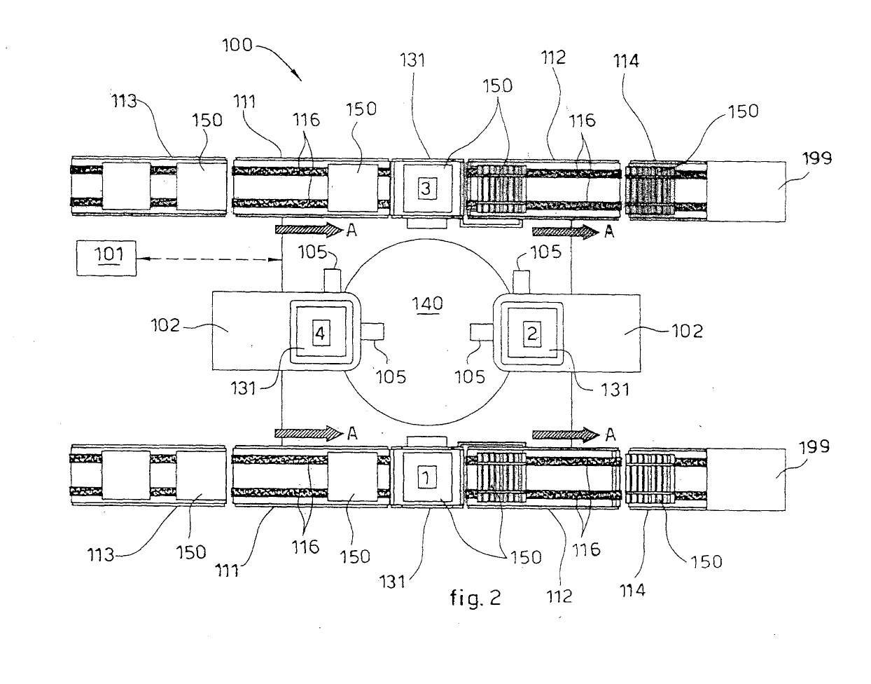

FIG. 2 is a schematic plan view of the system 100 depicted in FIG. 1. FIGS. 1 and 2 illustrate the system 100 having two processing nests 131 (in positions “1” and “3”) each positioned to both transfer a processed substrate 150 to the outgoing conveyor 112 and receive an unprocessed substrate 150 from the incoming conveyor 111.

Thus, in the system 100, the substrate motion generally follows the path “A” shown in FIGS. 1 and 2. In this configuration, the other two processing nests 131 (in positions “2” and “4”) are each positioned under a printing head 102 so that a process (e.g., screen printing, ink jet printing, material removal) can be performed on the unprocessed substrates 150 situated on the respective processing nests 131. Such a parallel processing configuration allows increased processing capacity with a minimized processing system footprint. Although the system 100 is depicted having two printing heads 102 and four processing nests 131, the system 100 may comprise additional printing heads 102 and/or processing nests 131 without departing from the scope of the present invention.

In one embodiment, the incoming conveyor 111 and outgoing conveyor 112 include at least one belt 116 to support and transport the substrates 150 to a desired position within the system 100 by use of an actuator (not shown) that is in communication with the system controller 101. While FIGS. 1 and 2 generally illustrate a two belt style substrate transferring system 116, other types of transferring mechanisms may be used to perform the same substrate transferring and positioning functions without varying from the basic scope of the invention.

In one embodiment, the system 100 also includes an inspection system 200, which is adapted to locate and inspect the substrates 150 before and after processing has been performed. The inspection system 200 may include one or more cameras 120 that are positioned to inspect a substrate 150 positioned in the loading/unloading positions “1” and “3,” as shown in FIGS. 1 and 2.

The inspection system 200 generally includes at least one camera 120 (e.g., CCD camera) and other electronic components that are able to locate, inspect, and communicate the results to the system controller 101. In one embodiment, the inspection system 200 locates the position of certain features of an incoming substrate 150 and communicates the inspection results to the system controller 101 for analysis of the orientation and position of the substrate 150 to assist in the precise positioning of the substrate 150 under a printing head 102 prior to processing the substrate 150.

In one embodiment, the inspection system 200 inspects the substrates 150 so that damaged or mis-processed substrates can be removed from the production line. In one embodiment, the processing nests 131 may each contain a lamp, or other similar optical radiation device, to illuminate the substrate 150 positioned thereon so that it can be more easily inspected by the inspection system 200.

The system controller 101 facilitates the control and automation of the overall system 100 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote.

Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes code to generate and store at least substrate positional information, the sequence of movement of the various controlled components, substrate inspection system information, and any combination thereof.

In one embodiment, the two printing heads 102 utilized in the system 100 may be conventional screen printing heads available from Applied Materials Italia Srl which are adapted to deposit material in a desired pattern on the surface of a substrate 150 disposed on a processing nest 131 in position “2” or “4” during a screen printing process. In one embodiment, the printing head 102 includes a plurality of actuators, for example, actuators 105 (e.g., stepper motors or servomotors) that are in communication with the system controller 101 and are used to adjust the position and/or angular orientation of a screen printing mask (not shown) disposed within the printing head 102 with respect to the substrate 150 being printed.

In one embodiment, the screen printing mask is a metal sheet or plate with a plurality of holes, slots, or other apertures formed therethrough to define a pattern and placement of screen printed material on a surface of a substrate 150. In one embodiment, the screen printed material may comprise a conductive ink or paste, a dielectric ink or paste, a dopant gel, an etch gel, one or more mask materials, or other conductive or dielectric materials.

In general, the screen printed pattern that is to be deposited on the surface of a substrate 150 is aligned to the substrate 150 in an automated fashion by orienting the screen printing mask using the actuators 105 and information received by the system controller 101 from the inspection system 200. In one embodiment, the printing heads 102 are adapted to deposit a metal containing or dielectric containing material on a solar cell substrate having a width between about 125 mm and 156 mm and a length between about 70 mm and 156 mm.

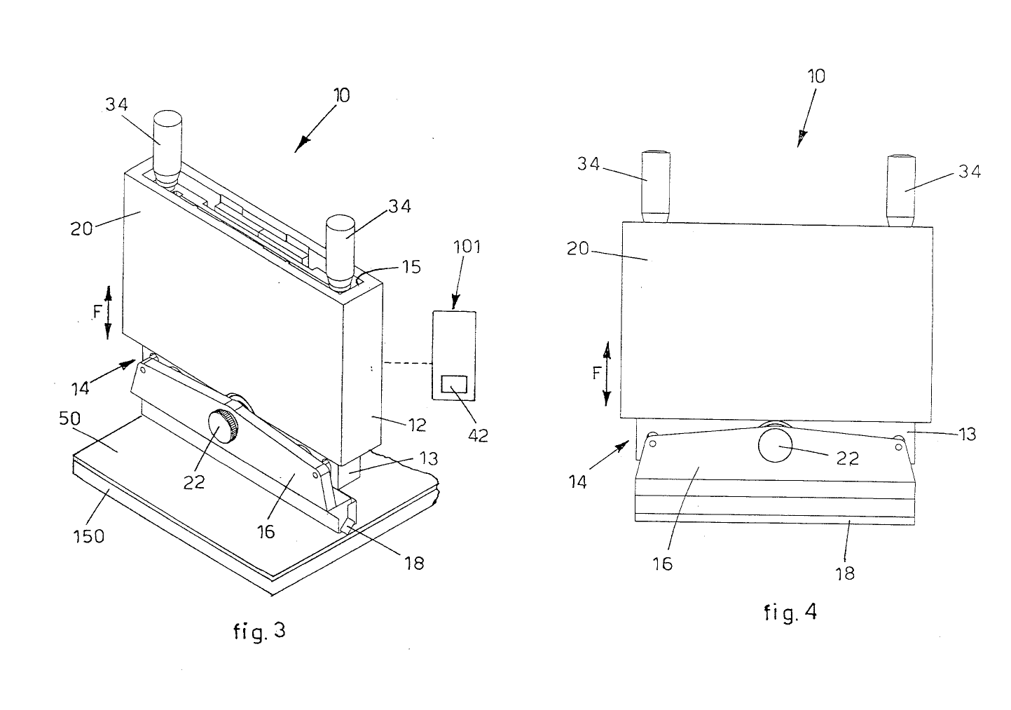

The blade 10 according to the invention comprises in this case a fixed support frame 12, able to be connected to a linear actuator, not shown in the drawings, which determines the typical translation movement, usually horizontal, of the blade 10 above the net 50, for the purposes of the printing operation (FIG. 3).

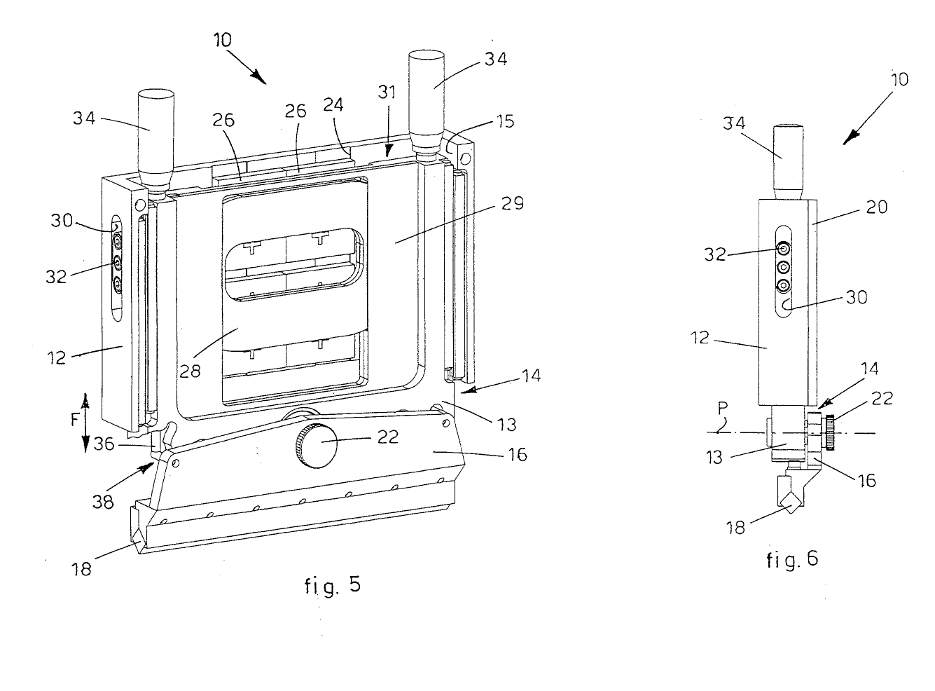

The frame 12 has a housing seating 15 (FIG. 3), in which a slider 14 is slidingly positioned, mobile in the direction indicated by the arrow F. For example, the slider 14 is able to move in the direction commonly known in the state of the art as direction Z, orthogonal to a plane XY commonly identified as the plane parallel to the plane on which the net lies and along which plane XY the blade 10 moves in order to carry out the printing operation (the associated Cartesian reference system XYZ is shown as an example in FIG. 5).

The frame 12 has laterally at least a sliding eyelet 30 (FIG. 5) in which a plurality of sliding elements are able to slide, of the rolling type 32, associated with the slider 14 to guide and support the motion of the slider 14 relative to the frame 12.

The slider 14 is hinged by means of a screw 22 (FIGS. 3, 4 and 5) to a lower rocker arm plate 16 which, in turn, supports and positions from below a print extremity 18. The print extremity 18 has a quadrangular shape developing along the length of the rocker arm plate 16 and is supported so as to face with one of its corners the net 50.

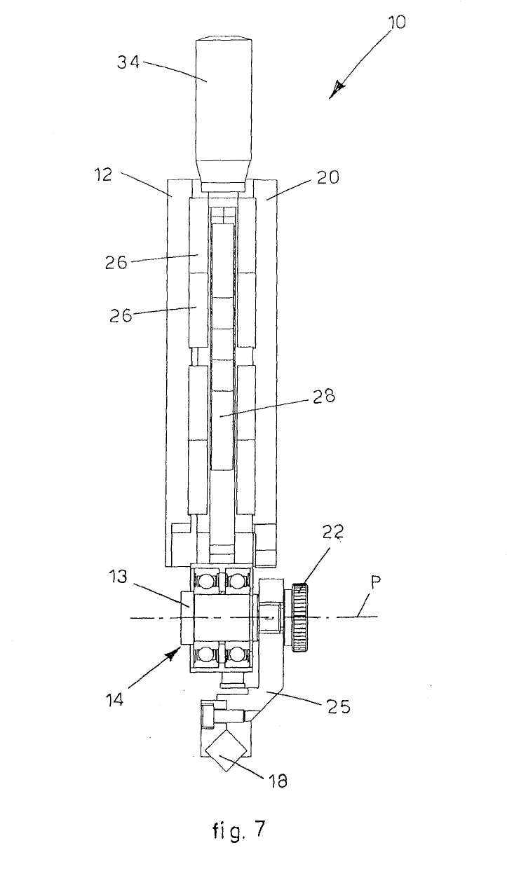

In particular, the rocker arm plate 16 is pivoted centrally about the screw 22 at a lower attachment end 15 of the slider 14. The pivoting allows a desired angular play of the print extremity 18 of the blade 10 around a pivoting axis P (FIGS. 6 and 7). In this way, being able to pivot around the P axis, the print extremity 18 is configured so as to adapt its facing corner to different or non homogeneous distribution of print material on the net 50.

A closing plate 20 is provided to close and contain the slider 14 in the housing seating 15 of the frame 12.

The frame 12 has other housing seatings 24, in which a plurality of permanent magnets 26 are disposed and fixed.

The magnets 26, in this case see the “+”polarities in FIG. 5, are able to generate a desired magnetic field of constant intensity.

The slider 14 comprises a support plate 29, attached by means of attachment elements such as screws 27. The support plate 29 defines in cooperation with the frame 12 an interstice 31 (FIG. 5), in which an electric coil 28 is provided, typically consisting of one or more spirals of a conductor material.

According to some embodiments, the electric coil 28 is of the type provided with a number of spirals chosen between about 100 and about 1000.

The electric coil 28 faces the magnets 26 and is attached and made solid with the support plate 29 of the slider 14.

The electric coil 28 is able to be fed with electric current, with a desired intensity and advantageously adjustable, for example in intensity and phase.

The electric current circulating in the electric coil 28 interacts with the magnetic field of the magnets 26, generating a magnetic force that determines a thrust on the electric coil 28, which, being fixed to the slider 14, consequently draws the latter in movement in the direction indicated by the arrow F (FIGS. 2 and 3).

Consequently, the combination of the magnets 26 and electric coil 28 defines, in this case, a movement system of the voice coil linear actuator type to control the movement of the blade in direction Z.

By controlling the current circulating in the electric coil 28 it is possible to selectively modify the electric coil 28 itself with respect to the magnets 26, for the purposes of positioning the slider 14 with respect to the support frame 12.

In particular, it is possible to selectively invert the direction of travel of the electric current in the electric coil 28 to determine the movement upward or downward (arrow F) of the slider 14 and therefore of the print extremity 18 of the blade 10.

Also, when no power is applied, and hence with no current circulating in the electric coil 28, the blade 10 descends downward due to gravity and the voice coil motor works by holding it in the raised position. This has the advantage that the weight of the blade 10 itself is used to determine the pressure in a desired way on the net 50.

The blade 10 comprises or is associated with the system controller 101. By use of software contained in memorization means, the system controller 101 is able to regulate the intensity of current circulating in the electric coil 28, so as to modulate the magnetic force that moves the slider 14.

In this way it is possible to control finely the position of the blade 10 along the axis Z, or in any case in a direction transverse to the net.

It is also possible, by varying the current in the electric coil 28, to regulate the pressure with which the blade 10, in particular the print extremity 18, acts on the net below.

Advantageously, the system controller 101 comprises memorization means 42, such as EEPROM, EPROM, FLASH memories or other kind of non volatile memories, in which an electronic map is memorized of the possible reciprocal positions of the electric coil 28 and the magnets 26, also associated with the possible intensities of current which, according to desired parameters, for example must circulate in the electric coil 28 in order to compensate the shorter or greater distance that the slider 14 has to travel. The electronic map may be pre-loaded in the memorization means 42, or may be loaded or upgraded when needed in a known way.

In this way it is possible, for example, to associate with each portion of the print extremity 18 a desired printing pressure, so as to apply, for example, the print extremity 18 to the net 50 in function of the specific print material deposited on the net 50 itself.

The blade 10, in association with the system to finely regulate the movement as above, according to a variant embodiment also comprises a pair of micrometric regulators 34, which allow to effect an adjustment that varies from fractions of a millimeter to fractions of a centimeter. In this case the micrometric regulators 34 are disposed in the housing seating 15, at the sides of the slider 14 and attached to, or in any case associated with, the support frame 12 (FIGS. 3-7).

The micrometric regulators 34 are provided with linear actuators 36 (FIG. 7), which are in turn directly coupled to opposite ends 38 of the rocker arm plate 16 and which are able to be activated, manually or automatically, for example by means of the system controller 101, to act on an end 38, in order to regulate the amplitude of the oscillation and the angular play of the blade 10 around the pivoting axis P.

By acting on the upper end of the micrometric regulators 34 it is possible to vary the extension of the linear actuators 36, and consequently to determine a desired angular limit to the amplitude of the oscillation of the rocker arm plate 16 which supports the print extremity 18 and thus obtain a better and accurate regulation of the blade 10 on the net 50.

It is clear that modifications and/or additions of parts may be made to the blade 10 for silk-screen printing on a substrate as described heretofore, without departing from the field and scope of the present invention.

It is also clear that, although the present invention has been described with reference to specific examples, a person of skill in the art shall certainly be able to achieve many other equivalent forms of blade for silk-screen printing on a substrate, having the characteristics as set forth in the claims and hence all coming within the field of protection defined thereby.

1-9. (canceled)

10. An apparatus for screen printing a surface of a substrate, comprising:
a screen printing net;
a print extremity element; and
a supporting structure supporting the print extremity element, the supporting structure comprising:
a slider coupled to the print extremity element and adapted to guide the movement of the print extremity element in a first direction;
a support frame having a housing that is associated with a portion of the slider so as to allow movement of the slider relative to the support frame; and
an actuation member coupled to the slider, wherein the print extremity element urges a print material through the screen printing net onto the surface of the substrate and wherein the actuation member positions the print extremity element relative to the screen printing net in the first direction.

11. The apparatus of claim 10, wherein the actuation member further comprises:
a plurality of magnets disposed within the housing of the support frame; and
an electric coil disposed proximate to the plurality of magnets.

12. The apparatus of claim 11, wherein the print extremity element is held at a desired position using a magnetic force generated between the plurality of magnets and the electric coil.

13. The apparatus of claim 12, wherein the magnetic force is formed by delivering an electric current through the electric coil.

14. The apparatus of claim 13, further comprising a system controller configured to change the direction of the electric current delivered through the electric coil and selectively position the slider and the print extremity element along the first direction.

15. The apparatus of claim 13, further comprising a system controller configured to control the intensity of the electric current delivered to the electric coil to position the slider and achieve a desired position of the print extremity element in the first direction.

16. The apparatus of claim 15, wherein the system controller further comprises a memory that is configured to store intensity values of the delivered electric currents according to the position of the slider relative to the support frame in the first direction.

17. The apparatus of claim 13, wherein the print extremity element is configured to descend in the first direction due to gravity when no electric current is delivered to the electric coil.

18. The apparatus of claim 11, wherein the electric coil is coupled to the slider and the magnets are coupled to the support frame.

19. The apparatus of claim 11, wherein the magnets are coupled to the slider and the electric coil is coupled to the support frame.

20. The apparatus of claim 10, further comprising:
a rocker arm plate coupled to the slider and to the print extremity element.

21. The apparatus of claim 20, further comprising:
a micrometric regulator, wherein the micrometric regulator comprises a linear actuator that is configured to position the rocker arm plate and the print extremity element relative to the slider.

22. The apparatus of claim 21, wherein the micrometric regulator is coupled to the housing of the support frame, and is configured to angularly position the print extremity element about a pivoting axis that is coupled to the slider.

23. An apparatus for screen printing a surface of a substrate, comprising:
a screen printing net having a plurality of apertures formed therein;
a print extremity element; and
a supporting structure supporting the print extremity element, the supporting structure comprising:
a slider coupled to the print extremity element and adapted to guide the movement of the print extremity element in a first direction;
a support frame having a housing that is associated with a portion of the slider so as to allow movement of the slider relative to the support frame; and
an actuation member coupled to the slider, the actuation member comprising:
a plurality of magnets disposed within the housing of the support frame; and
an electric coil disposed proximate to the plurality of magnets, wherein the print extremity element urges a print material through the screen printing net onto the surface of the substrate and wherein the actuation member positions the print extremity element relative to the screen printing net in the first direction.

24. The apparatus of claim 23, further comprising:
a rocker arm plate coupled to the slider and connected to the print extremity element.

25. The apparatus of claim 23, further comprising:
a micrometric regulator, wherein the micrometric regulator comprises a linear actuator that is configured to position the rocker arm plate and the print extremity element relative to the slider.

26. The apparatus of claim 23, wherein the actuation member coupled to the slider is an actuator of the voice coil type.

27. An apparatus for screen printing a surface of a substrate, comprising:
a screen printing net having a plurality of apertures formed therein, wherein the plurality of apertures define a pattern in which a print material is disposed on the surface of the substrate during a screen printing process;
a print extremity element configured to urge the print material through the apertures of the screen printing net;
a rocker arm plate coupled to the slider and the print extremity element;
a micrometric regulator, wherein the micrometric regulator comprises a linear actuator that is configured to position the rocker arm plate and the print extremity element relative to the slider; and
a supporting structure supporting the print extremity element, the supporting structure comprising:
a slider coupled to the print extremity element and adapted to guide the movement of the print extremity element in a first direction;
a support frame having a housing that is associated with a portion of the slider so as to allow movement of the slider relative to the support frame; and
an actuation member coupled to the slider, the actuation member comprising:
a plurality of magnets disposed within the housing of the support frame; and
an electric coil disposed proximate to the plurality of magnets.

28. The apparatus of claim 27, wherein the print extremity element is held at a desired position using a magnetic force generated in the first direction by the actuation member, and wherein the magnetic force is generated by delivering an electric current through the electric coil.

29. The apparatus of claim 28, wherein the print extremity element is configured to descend in the first direction due to gravity when no electric current is delivered to the electric coil.
